(19) United States
(12) Patent Application Publication
(10) Pub. No.: US 2024/0152578 A1
(43) Pub. Date: May 9, 2024

(54) SYSTEMS, METHODS, AND NON-TRANSITORY COMPUTER-READABLE STORAGE DEVICES FOR DETECTING AND ANALYZING DATA CLONES IN TABULAR DATASETS

(71) Applicant: HUAWEI TECHNOLOGIES CO., LTD., Shenzhen (CN)

(72) Inventors: Xu Yang, Kingston (CA); Gopi Krishnan Rajbahadur, Kingston (CA); Dayi Lin, Toronto (CA)

(21) Appl. No.: 18/386,023

(22) Filed: Nov. 1, 2023

Related U.S. Application Data
(60) Provisional application No. 63/424,088, filed on Nov. 9, 2022.

(51) Int. Cl. G06F 18/22; G06T 11/20

(52) U.S. Cl. CPC G06F 18/22; G06T 11/206

(57) ABSTRACT

A computerized method for detecting and analyzing data clones in one or more dataset pairs has the steps of: obtaining one or more similarity matrices and one or more sets of readout values of the one or more similarity matrices from the dataset pairs using a data-clone detection method, each set of readout values corresponding to a similarity matrix; obtaining one or more importance values for the one or more similarity matrices by processing the one or more sets of readout values using an interpretation method, each importance value corresponding to a similarity matrix; obtaining one or more weighted similarity matrices by weighting each similarity matrix using the corresponding importance value; and obtaining one or more summed similarity matrices by grouping and summing the weighted similarity matrices according to one or more categories for providing a result with indications of locations of the data clones in the dataset pairs.

### CROSS-REFERENCE TO RELATED APPLICATIONS

This application claims the benefit of U.S. Patent Application Ser. No. 63/424,088, filed Nov. 9, 2022, the content of which is incorporated herein by reference in its entirety.

### FIELD OF THE DISCLOSURE

The present disclosure relates generally to artificial-intelligence (AI) systems and methods, and in particular to AI systems, methods, and non-transitory computer-readable storage devices for detecting and analyzing data clones in tabular datasets.

### BACKGROUND

Tabular datasets are usually derived from data collected from multiple sources such as Internet and internal data stores. Such collection sources often contain similar data. As a result, the data collected therefrom, and subsequently the tabular datasets may contain similar or even same data items (also called “data clones”), which may lead to various issues and/or risks such as interferences in data processing.

### SUMMARY

According to one aspect of this disclosure, there is provided a computerized method comprising: obtaining one or more similarity matrices and one or more sets of readout values of the one or more similarity matrices from one or more dataset pairs using a data-clone detection method, each set of readout values corresponding to a respective similarity matrix; obtaining one or more importance values for the one or more similarity matrices by processing the one or more sets of readout values using an interpretation method, each importance value corresponding to a respective similarity matrix; obtaining one or more weighted similarity matrices by weighting each similarity matrix using the corresponding importance value; and obtaining one or more summed similarity matrices by grouping and summing the weighted similarity matrices according to one or more categories for providing an analytical result with indications of locations of the data clones in the one or more dataset pairs.

In some embodiments, the computerized method further comprises: generating one or more visualizations as the analytical result using the summed similarity matrices.

In some embodiments, the one or more visualizations comprise one or more heatmaps.

In some embodiments, each of the one or more heatmaps corresponds to one of the one or more categories.

In some embodiments, each of the one or more heatmaps comprises colors for indicating likelihoods of the data clones in the one or more dataset pairs.

In some embodiments, the interpretation method is a Shapley additive explanations (Shap) method, and the one or more importance values are Shap values.

In some embodiments, the one or more similarity matrices comprise one or more Jaccard indices, one or more SimHashes, one or more Levenshtein distances, one or more TextRanks, and/or one or more means and corresponding deviations.

According to one aspect of this disclosure, there is provided an artificial-intelligence (AI) system or one or more processors for executing the above-described method.

According to one aspect of this disclosure, there is provided one or more non-transitory computer-readable storage devices comprising computer-executable instructions, wherein the instructions, when executed, cause a processing structure to perform the above-described method.

The above-described AI systems, methods, and non-transitory computer-readable storage devices leverage the similarity matrices as the visualization target and use an interpretation method such as the Shap method as an explainable AI (XAI) tool to distribute weights to the matrices, thereby providing various advantages and benefits such as:
providing the analytical result with data-clone locations by combining similarity matrices with the XAI tool, thereby solving the problems that (i) the existence of data clones may not be determined by similarity calculation alone, and (ii) the location of a data clone may not be located by machine-learning models alone;
providing visualization of the analytical result which allows users to locate the data clones; and
maximizing and fading similarity values to remove “false positives” and making the visualization more viable by scaling similarity values of the similarity matrices using the feature-importance values obtained by the XAI tool.

### BRIEF DESCRIPTION OF THE DRAWINGS

For a more complete understanding of the disclosure, reference is made to the following description and accompanying drawings, in which:

FIG. 1A shows an example of the result obtained by the prior-art Shapley additive explanations (Shap) method for detection of data clones with post-prediction model interpretation;

FIG. 1B shows an example of a highlighted image obtained by the prior-art GradCAM method for showing the visual explanations of the decisions of convolutional neural network (CNN) based models;

FIG. 1C shows an example of a spreadsheet with highlighted data clone and clone cluster obtained by the prior-art method of data-clone detection and visualization in spreadsheets;

FIG. 2 is a simplified schematic diagram of an artificial intelligence (AI) system according to some embodiments of this disclosure;

FIG. 3 is a schematic diagram showing the hardware structure of the infrastructure layer of the AI system shown in FIG. 2, according to some embodiments of this disclosure;

FIG. 4 is a schematic diagram showing the hardware structure of a chip of the AI system shown in FIG. 2, according to some embodiments of this disclosure;

FIG. 5 is a schematic diagram of an AI model in the form of a deep neural network (DNN) used in the infrastructure layer shown in FIG. 3;

FIG. 6 is a schematic diagram showing an overall procedure of data-clone detection using the AI system shown in FIG. 2, according to some embodiments of this disclosure;

FIG. 7 is a flowchart showing the steps of a data-clone detection method performed by one or more processors of the AI system shown in FIG. 2, according to some embodiments of this disclosure;

FIG. 8 is a plot showing an example of the determined contributions of a plurality of similarity features in detecting the data-clones using the data-clone detection method shown in FIG. 7;

FIG. 9 shows an example of the dot product conducted by the data-clone detection method shown in FIG. 7;

FIGS. 10A to 10D are plots showing the heatmaps generated by the data-clone detection method shown in FIG. 7, wherein the heatmaps indicate the data-clone locations; and

FIGS. 11A and 11B are plots respectively showing two heatmaps generated by the data-clone detection method shown in FIG. 7 on two datasets, wherein the heatmaps are in symmetrical shapes indicating that the two datasets may contain same data.

### DETAILED DESCRIPTION

### Data Clones

As described above, tabular datasets often contain data clones. Herein, a “data clone” (that is, a piece of “cloned” data) refers to a substantial clone or duplicate of another piece of data notwithstanding that their presentations, forms, metadata, and/or the like may be different.

For example, a first data record or data item is a clone of a second data record or data item if:
(Type-1) the first data record or data item is an exact match of the second data record or data item although possibly with differences in metadata thereof such as different dates, file names, and/or the like;
(Type-2) the first data record or data item has exact content of the second data record or data item although possibly with differences in their formats;
(Type-3) the first data record or data item is a simple transformation of the second data record or data item; and/or
(Type-4) the first data record or data item is a complex transformation of the second data record or data item and is a derivative of the second data record or data item.

As another example, a piece of data (denoted “first tabular data”) in a first tabular dataset is a clone of at least a portion of a second tabular dataset if the first tabular data appears as a clone of some features of one or more cells, rows, and/or columns of the second tabular dataset.

For example, a row, column, or cell of data in a first tabular dataset (denoted “first tabular data”) is a clone of a row, column, or cell of data in a second tabular dataset (denoted “second tabular data”) if:
(Type-1) the first tabular data and the second tabular data have exact same group of adjacent cell values (with minimum k cells in the group);
(Type-2) the first tabular data and the second tabular data have the same contents although possibly with different text encoding;
(Type-3) the contents of the first tabular data and the second tabular data are substantially the same although possibly with minor differences in contents (for example, added or removed columns, rows, or cells) and/or presentation (for example, switching order of columns or rows, different numeric precisions (such as different roundings), and/or the like); and/or
(Type-4) the contents of the first tabular data and the second tabular data are substantially the same although possibly with differential privacy settings applied thereto. Herein, differential privacy quantifies the degrees of privacy protection to various datasets.

As yet another example, a first piece of image data such as a first image file is a clone of a second piece of image data such as a second image file if:
(Type-1) the first and second pieces of image data are the exact same image;
(Type-2) the first and second pieces of image data represent the exact same image content although possibly with different image formats;
(Type-3) the first piece of image data is a cropping, scaling and/or rotation of the second piece of image data; and/or
(Type-4) the first and second pieces of image data represent the exact same image although the first piece of image data possibly with perturbation of image, color adjustment, and/or the like.

As still another example, a first piece of programming code is a clone of a second piece of programming code if:
(Type-1) the first piece of programming code is syntactically identical to the second piece of programming code although possibly with different presentation style, comments, white spaces, and/or the like;
(Type-2) the first piece of programming code is a copy-and-pasted version of the second piece of programming code (that is, their contents are substantially the same) although possibly with changes of identifier names and types;
(Type-3) the first piece of programming code is a modified version of the second piece of programming code although possibly with statement-level changes (for example, additions of new statements, deletions of existing statements, modifications of existing statements, and/or the like); and/or
(Type-4) while the first piece of programming code is a syntactically dissimilar code fragment compared to the second piece of programming code, the first piece of programming code implements the same or similar functionality as the second piece of programming code.

Detecting data clones may facilitate identification of potential issues and/or risks such as issues in data processing caused by the interferences from data clones, untraceable or unmanageable toxic data and contaminated data during Extract, Transform, and Load (ETL), and/or the like. Detecting data clones of copyrighted data (such as copyrighted images, programming code, and/or the like) may also facilitate identification of potential legal risks such as using data that is not allowed for commercial use which may violate data license compliance and copyright laws.

Data-clone detection technologies are known. For example, Artificial intelligence (AI) may be used for detecting data clones. However, existing data-clone detection technologies often stop when a data clone is detected in datasets.

As existing data-clone detection technologies do not provide guidance on why and where the data-clone exists in the datasets, they may cause various difficulties in production environments, such as:
The AI model is not trustworthy since the prediction result is not explainable;
Even though the AI model is confident about the existence of a data clone. User cannot easily locate the data clone and remove the cloned data. More time and effort are still needed to locate the data clones in the datasets.

Thus, there is a need for explainable AI (XAI; also called “interpretable AI”) models for data-clone detection that can analyze the data-clone detection result and locate the data clones. Herein, the XAI is the AI in which humans can understand the predictions made by the AI.

With the analysis of the data-clone detection result, a data-clone visualization tool may also boost user's productivity.

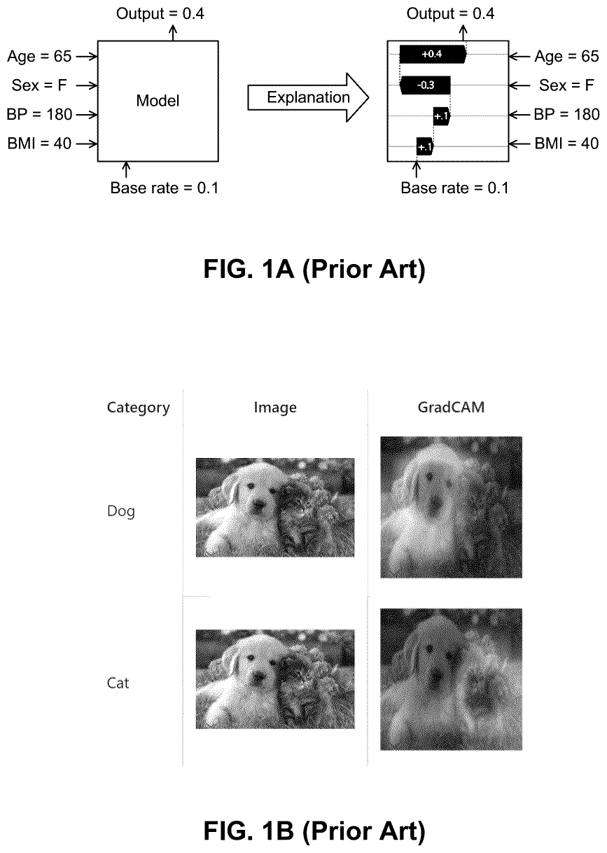

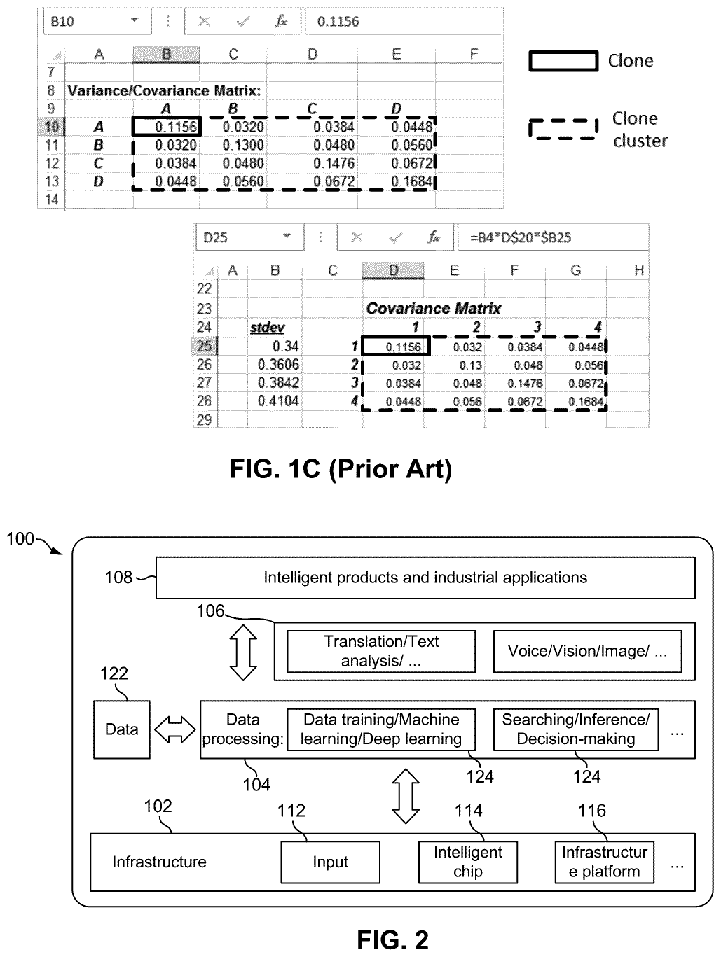

Shapley additive explanations (Shap) method is a post-prediction model interpretation method that can interpret complex machine-learning models. Shap is derived from game theory and uses game theory to assign credit for a model's prediction to each feature or feature value. When performing local interpretation, the core of Shap calculates the Shapley value of each of the characteristic variables. An example of Shap results is shown in FIG. 1A. The details of the Shap method can be found in the academic paper entitled “A Unified Approach to Interpreting Model Predictions” to Lundberg, et al., published in NIPS'17: Proceedings of the 31st International Conference on Neural Information Processing Systems, December 2017, Pages 4768-4777, and accessible at https://arxiv.org/abs/1705.07874, the content of which is incorporated herein by reference in its entirety.

In the Shap method, the Shap value provides reasoning for the predication of the model. It also provides which feature is contributing the most towards the prediction. However, it doesn't provide further visualization help for each of the features, especially when the feature is not a simple numeric value or string.

GradCAM is a technique in computer vision for showing the visual explanations of the decisions of convolutional neural network (CNN) based models. It calculates the gradient-weighted class activation mapping and uses the gradients of any target concept to produce a coarse localization map highlighting important regions in an image. An example of such highlighted image is shown in FIG. 1B.

GradCAM relies on gradient values in a deep neural network, which is not suitable for other classification models.

Methods of data-clone detection and visualization in spreadsheets is also available. As shown in FIG. 1C, the method locates a data clone in a spreadsheet by first locating identical cells and then using an algorithm to exam nearby cells to create clone clusters. However, this method only works for spreadsheets that do not contain a large number of cells, and its cluster-finding method limits its ability to detect clones that have row/column shifts (for example, Type-3 data clones).

### Artificial-Intelligence System

As described above, artificial intelligence (AI) may be used for detecting data clones. AI machines and systems usually comprise one or more AI models which may be trained using a large amount of relevant data for improving the precision of their perception, inference, and decision making.

Turning now to FIG. 2, an AI system for data-clone detection and analysis according to some embodiments of this disclosure is shown and is generally identified using reference numeral 100. The AI system 100 comprises an infrastructure layer 102 for providing hardware basis of the AI system 100, a data processing layer 104 for processing relevant data and providing various functionalities 106 as needed and/or implemented, and an application layer 108 for providing intelligent products and industrial applications.

The infrastructure layer 102 comprises necessary input components 112 such as sensors and/or other input devices for collecting input data, computational components 114 such as one or more intelligent chips, circuitries, and/or integrated chips (ICs), and/or the like for conducting necessary computations, and a suitable infrastructure platform 116 for AI tasks.

The one or more computational components 114 may be one or more central processing units (CPUs), one or more neural processing units (NPUs; which are processing units having specialized circuits for AI-related computations and logics), one or more graphic processing units (GPUs), one or more application-specific integrated circuits (ASICs), one or more field-programmable gate arrays (FPGAs), and/or the like, and may comprise necessary circuits for hardware acceleration.

The platform 116 may be a distributed computation framework with networking support, and may comprise cloud storage and computation, an interconnection network, and the like.

In FIG. 2, the data collected by the input components 112 are conceptually represented by the data-source block 122 which may comprise any suitable data such as sensor data (for example, data collected by Internet-of-Things (IoT) devices), service data, perception data (for example, forces, offsets, liquid levels, temperatures, humidities, and/or the like), and/or the like, and may be in any suitable form such as figures, images, voice clips, video clips, text, and/or the like.

The data processing layer 104 comprises one or more programs and/or program modules 124 in the form of software, firmware, and/or hardware circuits for processing the data of the data-source block 122 for various purposes such as data training, machine learning, deep learning, searching, inference, decision making, and/or the like.

In machine learning and deep learning, symbolic and formalized intelligent information modeling, extraction, preprocessing, training, and the like may be performed on the data-source block 122.

Inference refers to a process of simulating an intelligent inference manner of a human being in a computer or an intelligent system, to perform machine thinking and resolve a problem by using formalized information based on an inference control policy. Typical functions are searching and matching.

Decision making refers to a process of making a decision after inference is performed on intelligent information. Generally, functions such as classification, sorting, and inferencing (or prediction) are provided.

With the programs and/or program modules 124, the data processing layer 104 generally provides various functionalities 106 such as translation, text analysis, computer-vision processing, voice recognition, image recognition, and/or the like.

With the functionalities 106, the AI system 100 may provide various intelligent products and industrial applications 108 in various fields, which may be packages of overall AI solutions for productizing intelligent information decisions and implementing applications. Examples of the application fields of the intelligent products and industrial applications may be intelligent manufacturing, intelligent transportation, intelligent home, intelligent healthcare, intelligent security, automated driving, safe city, intelligent terminal, and the like.

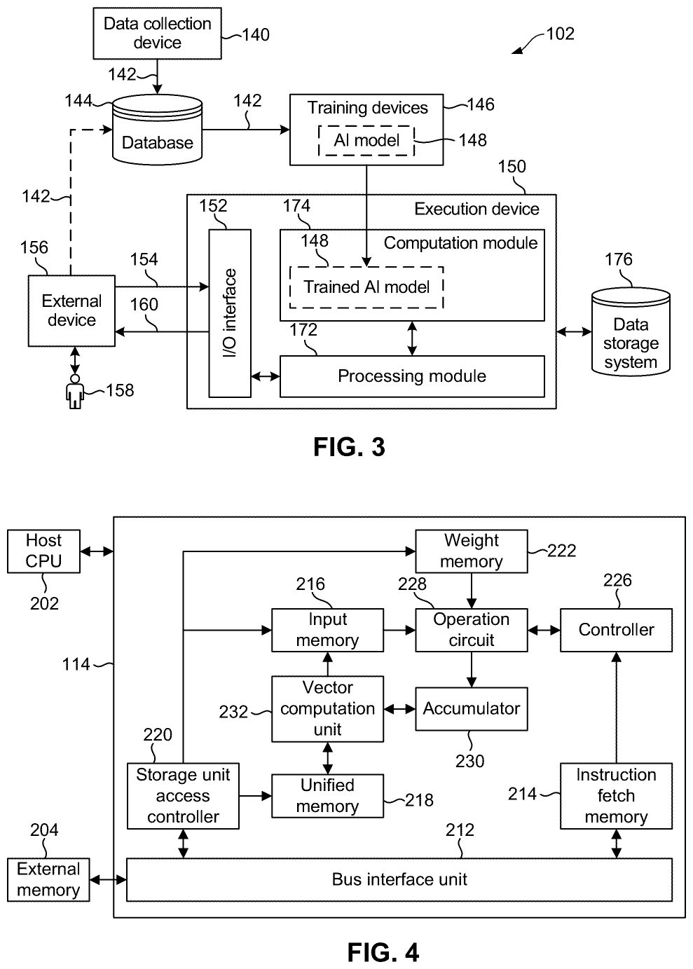

FIG. 3 is a schematic diagram showing the hardware structure of the infrastructure layer 102, according to some embodiments of this disclosure. As shown, the infrastructure layer 102 comprises a data collection device 140 for collecting training data 142 for training an AI model 148 (such as a machine-learning (ML) model, a neural network (NN) model (for example, a convolutional neural network (CNN) model), or the like) and storing the collected training data 142 into a training database 144. Herein, the training data 142 comprises a plurality of identified, annotated, or otherwise classified data samples that may be used for training (denoted “training samples” hereinafter) and corresponding desired results. Herein the training samples may be any suitable data samples to be used for training the AI model 148, such as one or more annotated images, one or more annotated text samples, one or more annotated audio clips, one or more annotated video clips, one or more annotated numerical data samples, and/or the like. The desired results are ideal results expected to be obtained by processing the training samples by using the trained or optimized AI model 148. One or more training devices 146 (such as one or more server computers forming the so-called “computer cloud” or simply the “cloud”, and/or one or more client computing devices similar to or same as the execution devices 150) use the training data 142 retrieved from the training database 144 to train the AI model 148 for use by the computation module 174 (described in more detail later).

As those skilled in the art will appreciate, in actual applications, the training data 142 maintained in the training database 144 may not necessarily be all collected by the data collection device 140, and may be received from other devices. Moreover, the training devices 146 may not necessarily perform training completely based on the training data 142 maintained in the training database 144 to obtain the trained AI model 148, and may obtain training data 142 from a cloud or another place to perform model training.

The trained AI model 148 obtained by the training devices 146 through training may be applied to various systems or devices such as an execution device 150 which may be a terminal such as a mobile phone terminal, a tablet computer, a notebook computer, an augmented reality (AR) device, a virtual reality (VR) device, a vehicle-mounted terminal, a server, or the like. The execution device 150 comprises an I/O interface 152 for receiving input data 154 from an external device 156 (such as input data provided by a user 158) and/or outputting results 160 to the external device 156. The external device 156 may also provide training data 142 to the training database 144. The execution device 150 may also use its I/O interface 152 for receiving input data 154 directly from the user 158.

The execution device 150 also comprises a processing module 172 for performing preprocessing based on the input data 154 received by the I/O interface 152. For example, in cases where the input data 154 comprises one or more images, the processing module 172 may perform image preprocessing such as image filtering, image enhancement, image smoothing, image restoration, and/or the like.

The processed data 142 is then sent to a computation module 174 which uses the trained AI model 148 to analyze the data received from the processing module 172 for prediction. As described above, the prediction results 160 may be output to the external device 156 via the I/O interface 152. Moreover, data 154 received by the execution device 150 and the prediction results 160 generated by the execution device 150 may be stored in a data storage system 176.

FIG. 4 is a schematic diagram showing the hardware structure of a computational component 114 according to some embodiments of this disclosure. The computational component 114 may be any processor suitable for large-scale exclusive OR operation processing, for example, a convolutional NPU, a tensor processing unit (TPU), a GPU, or the like. The computational component 114 may be a part of the execution device 150 coupled to a host CPU 202 for use as the computational module 160 under the control of the host CPU 202. Alternatively, the computational component 114 may be in the training devices 146 to complete training work thereof and output the trained AI model 148.

As shown in FIG. 4, the computational component 114 is coupled to an external memory 204 via a bus interface unit (BIU) 212 for obtaining instructions and data (such as the input data 154 and weight data) therefrom. The instructions are transferred to an instruction fetch buffer 214. The input data 154 is transferred to an input memory 216 and a unified memory 218 via a storage-unit access controller (or a direct memory access controller, DMAC) 220, and the weight data is transferred to a weight memory 222 via the DMAC 220. In these embodiments, the instruction fetch buffer 214, the input memory 216, the unified memory 218, and the weight memory 222 are on-chip memories, and the input data 154 and the weight data may be organized in matrix forms (denoted “input matrix” and “weight matrix”, respectively).

A controller 226 obtains the instructions from the instruction fetch buffer 214 and accordingly controls an operation circuit 228 to perform multiplications and additions using the input matrix from the input memory 216 and the weight matrix from the weight memory 222.

In some implementations, the operation circuit 228 comprises a plurality of processing engines (PEs; not shown). In some implementations, the operation circuit 228 is a two-dimensional systolic array. The operation circuit 228 may alternatively be a one-dimensional systolic array or another electronic circuit that may perform mathematical operations such as multiplication and addition. In some implementations, the operation circuit 228 is a general-purpose matrix processor.

For example, the operation circuit 228 may obtain an input matrix A (for example, a matrix representing an input image) from the input memory 216 and a weight matrix B (for example, a convolution kernel) from the weight memory 222, buffer the weight matrix B on each PE of the operation circuit 228, and then perform a matrix operation on the input matrix A and the weight matrix B. The partial or final computation result obtained by the operation circuit 228 is stored into an accumulator 230.

If required, the output of the operation circuit 228 stored in the accumulator 230 may be further processed by a vector calculation unit 232 such as vector multiplication, vector addition, an exponential operation, a logarithmic operation, size comparison, and/or the like. The vector calculation unit 232 may comprise a plurality of operation processing engines, and is mainly used for calculation at a non-convolutional layer or a fully connected layer (FC) of the convolutional neural network, and may specifically perform calculation in pooling, normalization, and the like. For example, the vector calculation unit 232 may apply a non-linear function to the output of the operation circuit 228, for example a vector of an accumulated value, to generate an active value. In some implementations, the vector calculation unit 232 generates a normalized value, a combined value, or both a normalized value and a combined value.

In some implementations, the vector calculation unit 232 stores a processed vector into the unified memory 218. In some implementations, the vector processed by the vector calculation unit 232 may be stored into the input memory 216 and then used as an active input of the operation circuit 228, for example, for use at a subsequent layer in the convolutional neural network.

The data output from the operation circuit 228 and/or the vector calculation unit 232 may be transferred to the external memory 204.

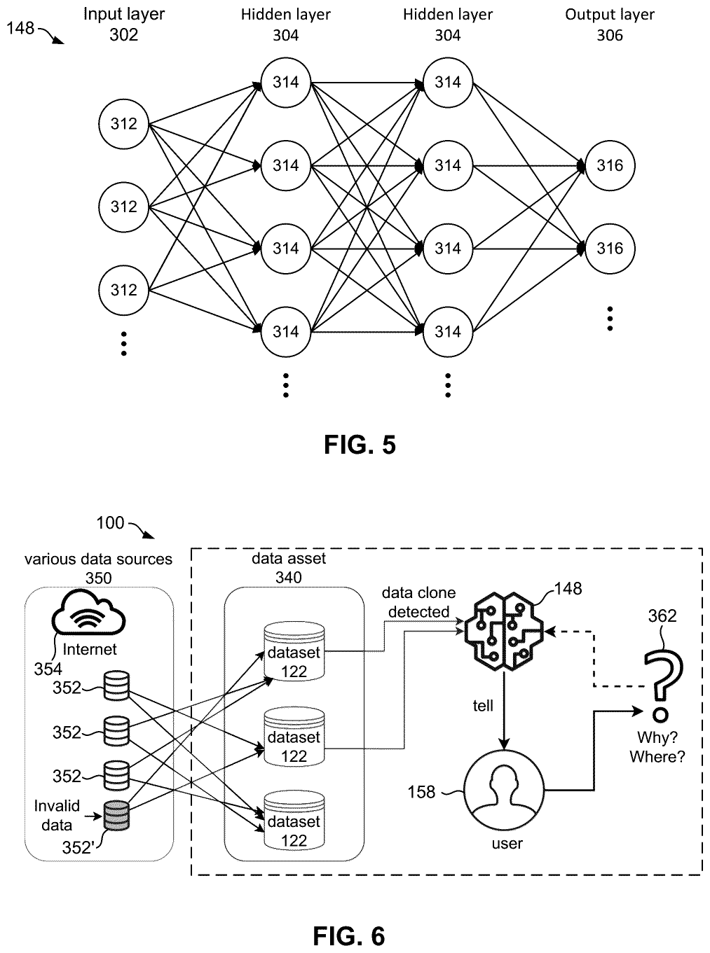

FIG. 5 is a schematic diagram of the AI model 148 in the form of a deep neural network (DNN). As shown, the DNN 148 comprises an input layer 302, a plurality of cascaded hidden layers 304, and an output layer 306. The trained AI model 148 may have a set of parameters optimized through the AI-model training.

The input layer 302 comprises a plurality of input nodes 312 for receiving input data and outputting the received data to the computation nodes 314 of the subsequent hidden layer 304. Each hidden layer 304 comprises a plurality of computation nodes 314. Each computation node 304 weights and combines the outputs of the input or computation nodes of the previous layer (that is, the input nodes 312 of the input layer 302 or the computation nodes 314 of the previous hidden layer 304, and each arrow representing a data transfer with a weight). The output layer 306 also comprises one or more output node 316, each of which combines the outputs of the computation nodes 314 of the last hidden layer 304 for generating the outputs.

As those skilled in the art will appreciate, the AI model such as the DNN 148 shown in FIG. 5 generally requires training for optimization. For example, a training device 146 (see FIG. 3) may provide training data 142 (which comprises a plurality of training samples with corresponding desired results) to the input nodes 312 to run through the AI model 148 and generate outputs from the output nodes 316. By comparing the outputs obtained from the output nodes 316 with the desired results in the training data 142, a loss function may be established and the parameters of the AI model 148, such as the weights thereof, may be optimized by minimizing the loss function.

### Data-Clone Detection Artificial-Intelligence System

The AI system 100 may execute a data-clone detection and analysis method for detecting and analyzing above-described Type-1, Type-2, and Type-3 data clones of tabular data in tabular datasets (that is, the data items in each dataset are arranged in matrix form having one or more rows, and one or more columns) with reasoning and locations of data clones. As shown in FIG. 6, the AI system 100 generally has the data asset 340 of a plurality of datasets 122, which may be obtained from various data sources 350 such as data 352 from the Internet 354. The data 352 may comprise invalid data 352′ in the form of data clones.

One or more execution devices 150 (not shown) of the AI system 100 execute the data-clone detection and analysis method and use a trained AI model 148 to detect data clones and report the detection of data clones to a user 158 with reasoning and locations 362 of the data clones.

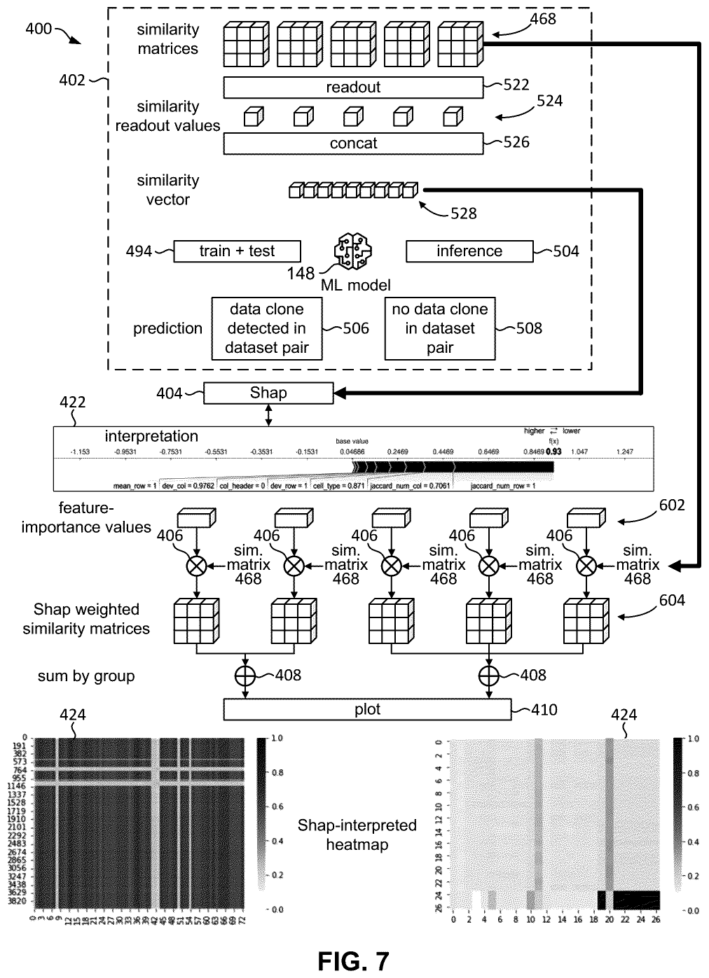

FIG. 7 is a flowchart showing the steps of the data-clone detection and analysis method 400 performed by one or more processors of the one or more execution devices 150 for detecting and analyzing data clones in a plurality of datasets 122, according to some embodiments of this disclosure.

At step 402, a data-clone detection method is used for combining the plurality of datasets 122 into one or more dataset pairs, and detecting data clones in the plurality of dataset pairs. For ease of illustration, block 402 in FIG. 7 only shows a portion of the data-clone detection method and blocks 468, 522, 524, 526, and 528 are applicable for each dataset pair.

More specifically, for each dataset pair, the data-clone detection method generates one or more similarity matrices 468, and then reads-out or otherwise generates one or more sets of readout values 524 from the one or more similarity matrices 468 with each set of readout values 524 corresponding to a respective similarity matrix 468. For ease of subsequent calculation, the one or more sets of readout values 524 form a similarity vector 528, or in some embodiments, form a three-dimensional (3D) similarity matrix (not shown).

The one or more sets of readout values 524 of each dataset pair (in the form of the similarity vector 528 or the 3D similarity matrix) is applied to the AI model 148 to infer or otherwise detect the existence 506 or nonexistence 508 of one or more data clones in the dataset pair. For ease of description, the dataset pairs inferred or otherwise detected to have (block 506) one or more data clones are denoted “positive dataset pairs 506”, and the dataset pairs inferred or otherwise detected not to have (block 508) one or more data clones are denoted “negative dataset pairs 508”.

In these embodiments, each set of readout values 524, and accordingly each similarity matrix 468, corresponds to a similarity feature and may be classified into a similarity category (described in more detail later). The readout values 524 (or the similarity vectors 528 or 3D similarity matrices) of the positive dataset pairs 506 are fed into an interpretation method to interpret the similarity features thereof (for example, by using a trained interpretation AI model) and generate an interpretation 422 (step 404).

The generated interpretation 422 comprises one or more importance values 602 corresponding to the one or more similarity matrices 468. At step 406, each similarity matrix 468 of each positive dataset pair 506 is weighted by the corresponding importance value 602 (for example, by calculating the dot product thereof) to obtain a weighted similarity matrix 604 (step 406). Then, the weighted similarity matrices 604 are grouped by their similarity categories (step 408) and are plotted (step 410) for visualization 424.

For example, at step 402, the data-clone detection method disclosed in copending U.S. provisional application No. 63/423,918, entitled “SYSTEMS, METHODS, AND NON-TRANSITORY COMPUTER-READABLE STORAGE DEVICES FOR DETECTING DATA CLONES IN TABULAR DATASETS”, and filed on Nov. 9, 2022, the content of which is incorporated herein by reference in its entirety, may be used for detecting data clones 506 in a plurality of tabular datasets 122. As those skilled in the art understand, a tabular dataset 122 comprises one or more data items arranged in a tabular manner for example, in one or more rows and one or more columns.

Generally, this data-clone detection method combines the plurality of N datasets 122 into a plurality of

$$( \begin{matrix}N \\ 2\end{matrix} )$$

different dataset pairs with each dataset pair being a selection or combination of two datasets from the N tabular datasets 122.

The data items of each dataset-pair are combined in one or more arrangement levels such as one or more of rows, columns, cells, and the like. For example, combining in rows gives rise to row-combinations each having two rows from the two datasets 122 of the dataset-pair. Combining in columns gives rise to column-combinations each having two columns from the two datasets 122 of the dataset-pair.

Then, one or more similarities are calculated for each dataset pair by using one or more similarity metrics and the combinations of the data items (such as the row-combinations and column combinations) of the dataset pair to obtain a plurality of similarity matrices 468 including one or more row-similarity matrices and one or more column-similarity matrices for the dataset pair.

As those skilled in the art will appreciate, the similarity metrics may be dependent upon the data types of the tabular datasets 122. For example, a similarity metric for string data may be, for example, a Jaccard index, a SimHash, a Levenshtein distance, a TextRank, or the like. A similarity metric for numerical data may be, for example, a Jaccard index, a mean and corresponding deviation, and the like.

The obtained similarity matrices 468 are readout (step 522) using, for example, a mean_topK readout method, which calculates the mean value of the largest K (K≥1 is an integer) elements in each similarity matrix as the similarity readout value 524 of the similarity matrix 468.

The one or more similarity readout values 524 of each dataset pair are concatenated (step 526) or otherwise combined into a similarity vector 528 for the dataset pair, which may be used in a training and testing phase for training and testing (step 494) the AI model 148 (such as a machine-learning (ML) model), or in an inference phase for generating inference (step 504) of the existence 506 or nonexistence 508 of data clones in each dataset pair.

As described above, each similarity matrix 468 corresponds to a similarity feature. The specific similarity features may be dependent upon the similarity matrices used for data-clone detection. In this example, each similarity feature is the readout value 524 of a similarity matrix 468, and thus the similarity features may be the Jaccard index similarity of numerical data on row-row calculation, the Jaccard index similarity of string data on row-row calculation, the Jaccard index similarity of numerical data on column-column calculation, the Jaccard index similarity of string data on column-column calculation, the deviation of numerical data on row-row calculation, the deviation of numerical data on column-column calculation, the mean of numerical data on row-row calculation, the mean of numerical data on column-column calculation, the SimHash of string data on row-row calculation, the SimHash of string data on column-column calculation, TextRank of string data on row-row calculation, TextRank of string data on column-column calculation, and/or the like.

In some embodiments, at step 404, the Shap method is used as the interpretation method to analyze the similarity features of the similarity vectors 528 of the positive dataset pairs 506. The Shap method uses the game theory as the carrier to calculate the contribution 602 (also denoted the “Shap value” or the “feature-importance value”) of each similarity feature of the similarity vectors 528 in determining the positive dataset pairs 506, and may comprise an interpretation AI model trained using a training and testing procedure similar to that used in step 494.

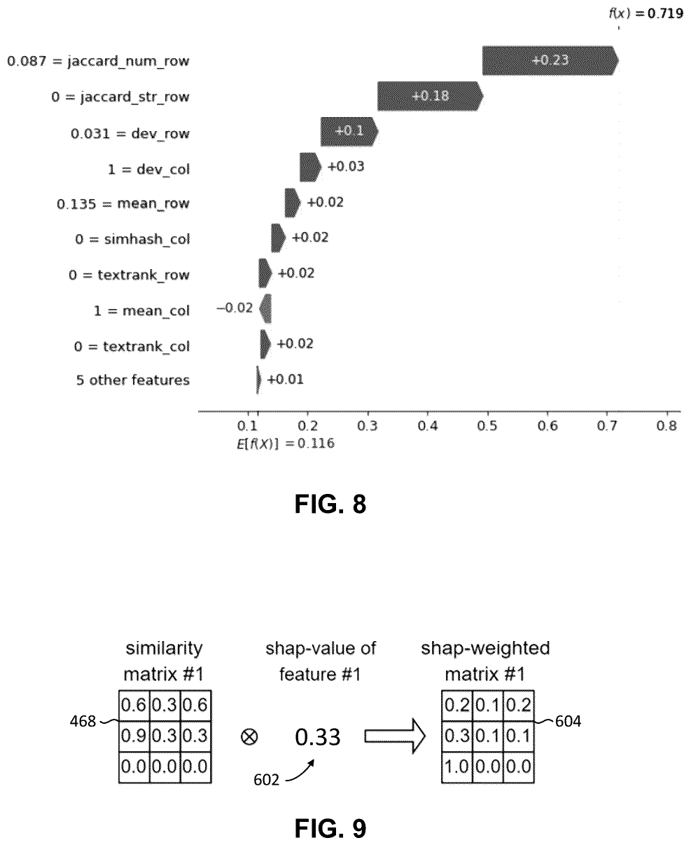

FIG. 8 is a plot showing an example of the determined contributions 602 of the similarity features in determining a positive dataset pair 506. In this example, the AI model 148 has a confidence of 0.719 that there exists a data clone in the positive dataset pair 506. The similarity feature Jaccard_num_row (that is, the Jaccard index similarity of numerical data on row-row calculation) provides the most contribution of about 0.23 in determining the positive dataset pair 506 using the AI model 148, and the similarity feature Jaccard_num_col (that is, the Jaccard index of numerical columns) provides a contribution of about 0.18 in determining the positive dataset pair 506 using the AI model 148. The contributions of other similarity features are also shown. Clearly, some similarity features have small contributions and are not important in determining the positive dataset pairs 506 using the AI model 148.

In other words, while the similarity matrices may indicate the similarity of the datasets 122, small-contribution features may cause “false positives”. Therefore, in the following steps, the data-clone detection and analysis method 400 emphasizes or promotes the large-contribution features and demotes or fades the small-contribution features to remove “false positives”.

Referring back to FIG. 7, at step 406, the dot product of each similarity matrix 468 and the corresponding Shap value 602 is calculated to obtain a Shap-weighted similarity matrix 604. FIG. 9 shows an example of the dot product, wherein the values of the similarity matrix 468 and the resulted Shap-weighted matrix 604 are rounded to one digit.

Thus, the similarity matrices 468 and the similarity features are “scaled” by the corresponding Shap values 602, wherein the important similarity features are “amplified”, and the insignificant similarity features are “faded”.

Each similarity matrix 468, and accordingly each Shap-weighted similarity matrix 604, may be classified into a similarity category. For example, “Jaccard_num_col” represents the Jaccard index similarity of numerical data on column-column calculation, and thus has a type of numerical data and a dimension of column. Similarly, “Jaccard_str_row” represents the Jaccard index similarity of string data on row-row calculation, and thus has a type of string data and a dimension of row. Thus, in this example, each similarity matrix 468, and accordingly each Shap-weighted similarity matrix 604, has a data type of numeric or string, and a dimension of row or column, thereby resulting in four similarity categories including string_row, string_column, numeric_row, and numeric_column.

At step 408, the Shap-weighted similarity matrices 604 are grouped by their similarity categories, and the Shap-weighted similarity matrices 604 of the same categories are summed to obtain one or more summed similarity matrices each for a corresponding similarity category. The one or more summed similarity matrices may be used for plotting (step 410), for example, one or more heatmaps 424 for visualization, wherein each heatmap 424 corresponds to a respective similarity category, and darker colors indicate higher chances (or likelihoods or probabilities) of having a data clone.

Thus, the above-described data-clone detection and analysis method 400 provides an intuitive reasoning and fine-grained result for user to find the exact location of data clones in a plurality of datasets 122 (or more specifically, in a plurality of dataset pairs built from the plurality of datasets 122), thereby facilitating the user's real-world productivity.

As those skilled in the art will appreciate, in various embodiments, the above-described data-clone detection and analysis method 400 may use any suitable data-clone detection method that generates similarity matrices during data-clone detection, and may collaborate with the data-clone detection method simultaneously and automatically for detecting, analyzing, and visualizing data clones in a plurality of datasets 122 (or more specifically in positive dataset pairs 506). The interpretation, analysis, and visualization steps 404, 408, and 410 may be performed on the positive dataset pairs 506 after the inference stage of the data-clone detection method.

The data-clone detection and analysis method 400 returns the analytical result with data-clone locations. Such analytical result is based on the combination of similarity matrices and the XAI tool, which solves the problems that (i) similarity calculation alone may not be able to determine the existence 506 of data clones, and (ii) machine-learning models 148 alone may not be able to determine the location of a data clone.

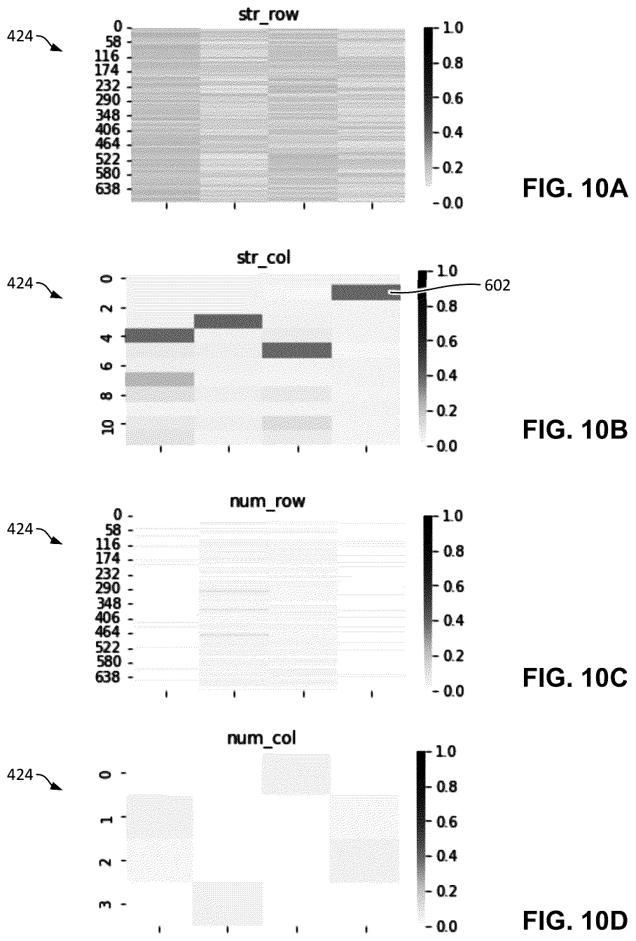

The analytical result obtained by the data-clone detection and analysis method 400 may be used in any suitable manner. For example, in above embodiments, the analytical result (for example, the one or more summed similarity matrices) may be visualized by using, for example, one or more heatmaps 424, in which dark spots indicate the data-clone locations. Then, the user may check the coordinated data to delete/modified the data. For example, FIGS. 10A to 10D show a plurality of heatmaps 424 each corresponding to a respective data-type/dimension category. As shown in FIG. 10B, the string_column heatmap indicates that a string-type data-clone is in location (1, 3).

In some embodiments, the data-clone detection and analysis method 400 may be used for identifying datasets that not only contain one or more data clones, but also contains one or more fragments that are exactly identical, which might occur when the dataset are being transformed, segmented, or algorithmically proceed (for example, with differential privacy). In these embodiments, the shapes of similarity matrices, or specifically the symmetry thereof, may be provide a strong indication about whether or not the datasets may contain same data from the same data sources but may be processed differently (for example, having different formats).

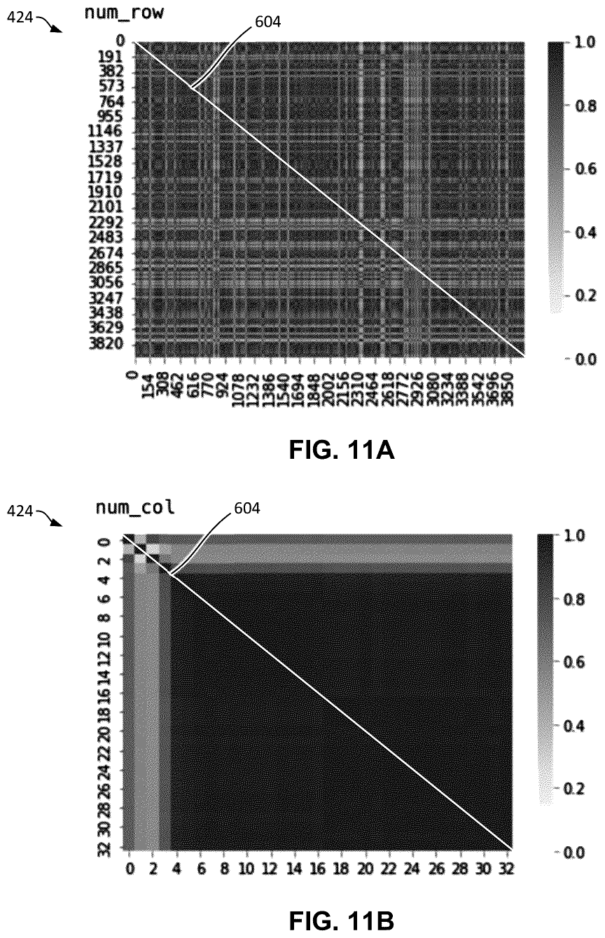

For example, FIGS. 11A and 11B respectively show the numeric_row and numeric_column heatmaps 424 obtained by the data-clone detection and analysis method 400 on two datasets. In FIG. 11A, the horizontal and vertical axes represent the row numbers of the first and second datasets, respectively. In FIG. 11B, the horizontal and vertical axes represent the column numbers of the first and second datasets, respectively. As can be seen, each heatmap 424 is symmetrical with respect to the diagonal line 604. In other words, the values in FIG. 11A, denoted NR(i,j) (wherein i and j represent the row numbers of the first and the second datasets, respectively) are the same for the same row-number combination, that is, NR (i,j)=NR(j,i). Similarly, the values in FIG. 11B, denoted NC(i,j) (wherein i and j represent the column numbers of the first and the second datasets, respectively) are the same for the same column-number combination, that is, NC(i,j)=NC(j,i). Such a symmetry of similarity matrices indicates that the two datasets may contain same data, although the two datasets may be obtained from the same data via different data processings.

The AI system 100 and the data-clone detection and analysis method 400 disclosed herein leverage the similarity matrices as the visualization target and use an interpretation method such as the Shap method as the XAI tool to distribute weights to the matrices, thereby providing various advantages and benefits such as:
providing the analytical result with data-clone locations by combining similarity matrices with the XAI tool, thereby solving the problems that (i) the existence of data clones may not be determined by similarity calculation alone, and (ii) the location of a data clone may not be located by machine-learning models alone;
providing visualization of the analytical result which allows users to locate the data clones; and maximizing and fading similarity values to remove “false positives” and making the visualization more viable by scaling similarity values of the similarity matrices using the feature-importance values obtained by the XAI tool.

Although embodiments have been described above with reference to the accompanying drawings, those of skill in the art will appreciate that variations and modifications may be made without departing from the scope thereof as defined by the appended claims.

What is claimed is:

1. A computerized method comprising:
obtaining one or more similarity matrices and one or more sets of readout values of the one or more similarity matrices from one or more dataset pairs using a data-clone detection method, each set of readout values corresponding to a respective similarity matrix;
obtaining one or more importance values for the one or more similarity matrices by processing the one or more sets of readout values using an interpretation method, each importance value corresponding to a respective similarity matrix;
obtaining one or more weighted similarity matrices by weighting each similarity matrix using the corresponding importance value; and
obtaining one or more summed similarity matrices by grouping and summing the weighted similarity matrices according to one or more categories for providing an analytical result with indications of locations of the data clones in the one or more dataset pairs.

2. The computerized method of claim 1 further comprising:
generating one or more visualizations as the analytical result using the summed similarity matrices.

3. The computerized method of claim 2, wherein the one or more visualizations comprise one or more heatmaps.

4. The computerized method of claim 3, wherein each of the one or more heatmaps corresponds to one of the one or more categories.

5. The computerized method of claim 3, wherein, each of the one or more heatmaps comprises colors for indicating likelihoods of the data clones in the one or more dataset pairs.

6. The computerized method of claim 1, wherein the interpretation method is a Shapley additive explanations (Shap) method, and the one or more importance values are Shap values.

7. The computerized method of claim 1, wherein the one or more similarity matrices comprise one or more Jaccard indices, one or more SimHashes, one or more Levenshtein distances, one or more TextRanks, and/or one or more means and corresponding deviations.

8. One or more processors for performing actions comprising:
obtaining one or more similarity matrices and one or more sets of readout values of the one or more similarity matrices from one or more dataset pairs using a data-clone detection method, each set of readout values corresponding to a respective similarity matrix;
obtaining one or more importance values for the one or more similarity matrices by processing the one or more sets of readout values using an interpretation method, each importance value corresponding to a respective similarity matrix;
obtaining one or more weighted similarity matrices by weighting each similarity matrix using the corresponding importance value; and
obtaining one or more summed similarity matrices by grouping and summing the weighted similarity matrices according to one or more categories for providing an analytical result with indications of locations of the data clones in the one or more dataset pairs.

9. The one or more processors of claim 8 for performing further actions comprising:
generating one or more visualizations as the analytical result using the summed similarity matrices.

10. The one or more processors of claim 9, wherein the one or more visualizations comprise one or more heatmaps.

11. The one or more processors of claim 10, wherein, each of the one or more heatmaps comprises colors for indicating likelihoods of the data clones in the one or more dataset pairs.

12. The one or more processors of claim 8, wherein the interpretation method is a Shapley additive explanations (Shap) method, and the one or more importance values are Shap values.

13. The one or more processors of claim 8, wherein the one or more similarity matrices comprise one or more Jaccard indices, one or more SimHashes, one or more Levenshtein distances, one or more TextRanks, and/or one or more means and corresponding deviations.

14. One or more non-transitory computer-readable storage devices comprising computer-executable instructions, wherein the instructions, when executed, cause a processing structure to perform actions comprising:
obtaining one or more similarity matrices and one or more sets of readout values of the one or more similarity matrices from one or more dataset pairs using a data-clone detection method, each set of readout values corresponding to a respective similarity matrix;
obtaining one or more importance values for the one or more similarity matrices by processing the one or more sets of readout values using an interpretation method, each importance value corresponding to a respective similarity matrix;
obtaining one or more weighted similarity matrices by weighting each similarity matrix using the corresponding importance value; and
obtaining one or more summed similarity matrices by grouping and summing the weighted similarity matrices according to one or more categories for providing an analytical result with indications of locations of the data clones in the one or more dataset pairs.

15. The one or more non-transitory computer-readable storage devices of claim 14, wherein the actions further comprising:
generating one or more visualizations as the analytical result using the summed similarity matrices.

16. The one or more non-transitory computer-readable storage devices of claim 15, wherein the one or more visualizations comprise one or more heatmaps.

17. The one or more non-transitory computer-readable storage devices of claim 16, wherein each of the one or more heatmaps corresponds to one of the one or more categories.

18. The one or more non-transitory computer-readable storage devices of claim 16, wherein, each of the one or more heatmaps comprises colors for indicating likelihoods of the data clones in the one or more dataset pairs.

19. The one or more non-transitory computer-readable storage devices of claim 14, wherein the interpretation method is a Shapley additive explanations (Shap) method, and the one or more importance values are Shap values.

20. The one or more non-transitory computer-readable storage devices of claim 14, wherein the one or more similarity matrices comprise one or more Jaccard indices, one or more SimHashes, one or more Levenshtein distances, one or more TextRanks, and/or one or more means and corresponding deviations.
